(19) United States
(12) Patent Application Publication
(10) Pub. No.: US 2021/0331682 A1
(43) Pub. Date: Oct. 28, 2021

(54) OPERATION METHOD OF AUTONOMOUS VEHICLE USING AUTHENTICATION CODE

(71) Applicant: LG ELECTRONICS INC., Seoul (KR)

(72) Inventor: Chiwon SONG, Seoul (KR)

(73) Assignee: LG ELECTRONICS INC., Seoul (KR)

(21) Appl. No.: 16/494,151

(22) PCT Filed: Jun. 18, 2019
(86) PCT No.: PCT/KR2019/007358

§ 371 Date: Sep. 13, 2019

(51) Int. Cl. B60W 40/08; G05D 1/00; B60W 60/00; G06F 21/34; B60W 10/30

(52) U.S. Cl. CPC B60W 40/08; G05D 1/0011; B60W 60/00256; G06F 21/34; G05D 2201/0213; B60W 2540/045; B60W 2540/043; B60W 2420/42; B60W 10/30

(57) ABSTRACT

The present invention relates to an operation method of an autonomous vehicle in which the autonomous vehicle validates a user's authority to control the autonomous vehicle through an authentication code and operates based on control information matched to the authentication code. In accordance with an aspect of the present invention, an operation method of an autonomous vehicle using an authentication code includes: generating a first authentication code; matching control information to the first authentication code; transmitting the first authentication code to a user terminal; identifying a second authentication code through a camera; performing validation by ascertaining whether the second authentication code is identical to the first authentication code; identifying control information matched to the second authentication code based on a validation result; and operating based on the identified control information.

### TECHNICAL FIELD

The present invention relates to an operation method of an autonomous vehicle, in which the autonomous vehicle validates a user's authority to control the autonomous vehicle through an authentication code and operates based on control information matched to the authentication code.

### BACKGROUND ART

Recently, techniques for autonomous vehicles capable of traveling to a destination without driver intervention are under development. At the same time, various services based on an autonomous vehicle are attracting attention as a future industry.

On the other hand, delivery services are expanding due to increase in remote purchase of goods, such as online shopping. For a delivery service, a vehicle capable of being loaded with multiple deliveries is required and the deliveries loaded on the vehicle are delivered directly to respective destinations by a deliveryman.

However, such a delivery method has a problem in that deliveries are likely to be damaged in the process of being directly delivered by a deliveryman or to be lost when the deliveryman stays away from a delivery vehicle.

Therefore, there is a need for a method capable of safely delivering goods to customers by integrating an autonomous vehicle into a delivery service.

### DISCLOSURE

### Technical Problem

It is one aspect of the present invention to provide an operation method of an autonomous vehicle, in which the autonomous vehicle validates a user's authority to control the autonomous vehicle through an authentication code and operates in a limited manner based on control information matched to the authentication code

The above and other aspects and advantages of the present invention will become apparent from the detailed description of the following embodiments in conjunction with the accompanying drawings. In addition, it will be readily understood that the aspects and advantages of the present invention can be realized by features set forth in the appended claims or combinations thereof.

### Technical Solution

In accordance with one aspect of the present invention, an operation method of an autonomous vehicle using an authentication code includes: generating a first authentication code; matching control information to the first authentication code; transmitting the first authentication code to a user terminal; identifying a second authentication code through a camera; performing validation by ascertaining whether the second authentication code is identical to the first authentication code; identifying control information matched to the second authentication code based on a validation result; and operating based on the identified control information.

### Advantageous Effects

According to the present invention, an autonomous vehicle can prevent an unauthorized user from controlling the autonomous vehicle by validating a user's authority to control the autonomous vehicle through an authentication code and allowing the autonomous vehicle to operate in a limited manner based on control information matched to the authentication code; and can prevent a user from misusing or abusing functions of the autonomous vehicle by providing a limited authority to the user.

The above and other advantageous effects of the present invention will be further described in the following description of details for implementing the present invention.

### DESCRIPTION OF DRAWINGS

FIG. 1 is a diagram of an autonomous vehicle control system according to one embodiment of the present invention.

FIG. 2 is an internal configuration diagram illustrating an operation and control flow of an autonomous vehicle.

FIG. 3 is a flowchart of a process of operating an autonomous vehicle using an authentication code according to one embodiment of the present invention.

FIG. 4 is a diagram of an example of the autonomous vehicle of FIG. 1.

FIG. 5 is a table illustrating exemplary authentication codes and control information matched thereto.

FIG. 6 and FIG. 7 are views illustrating operation of an autonomous vehicle when the autonomous vehicle is in need of additional control due to external factors.

### BEST MODE

Hereinafter, embodiments of the present invention will be described with reference to the accompanying drawings such that the present invention can be easily implemented by those skilled in the art. Description of known functions and constructions which may unnecessarily obscure the subject matter of the present invention will be omitted. In the drawings, like components will be denoted by like reference numerals throughout the specification.

The present invention relates an operation method of an autonomous vehicle, in which the autonomous vehicle validates a user's authority to control the autonomous vehicle through an authentication code and operates based on control information matched to the authentication code.

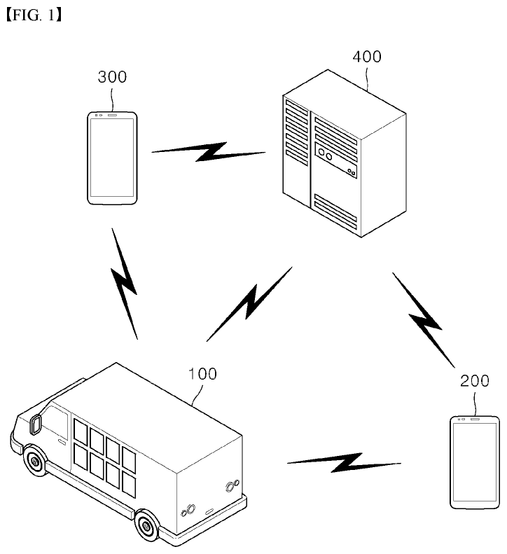

Now, an autonomous vehicle control system according to one embodiment of the present invention and an operation method of an autonomous vehicle using an authentication code in the system will be described in detail with reference to FIG. 1 to FIG. 7.

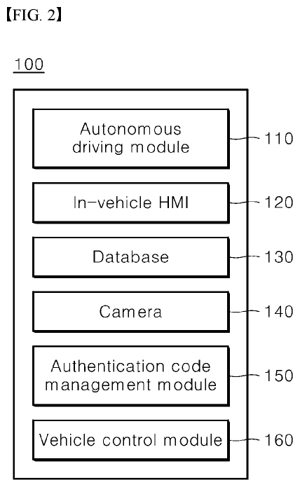

FIG. 1 is a diagram of an autonomous vehicle control system according to one embodiment of the present invention. FIG. 2 is an internal configuration diagram illustrating the operation and control flow of an autonomous vehicle.

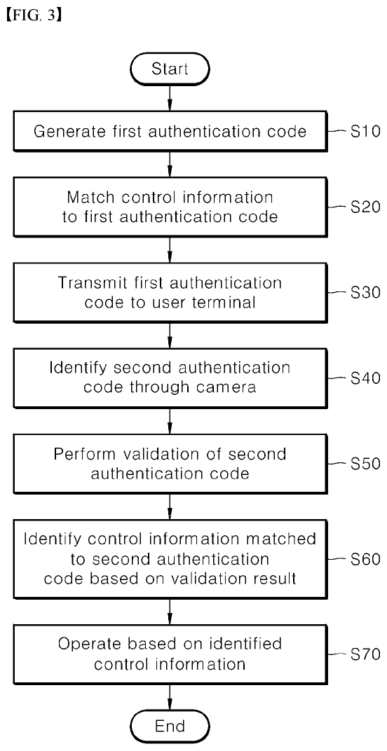

FIG. 3 is a flowchart of an operation method of an autonomous vehicle using an authentication code according to one embodiment of the present invention.

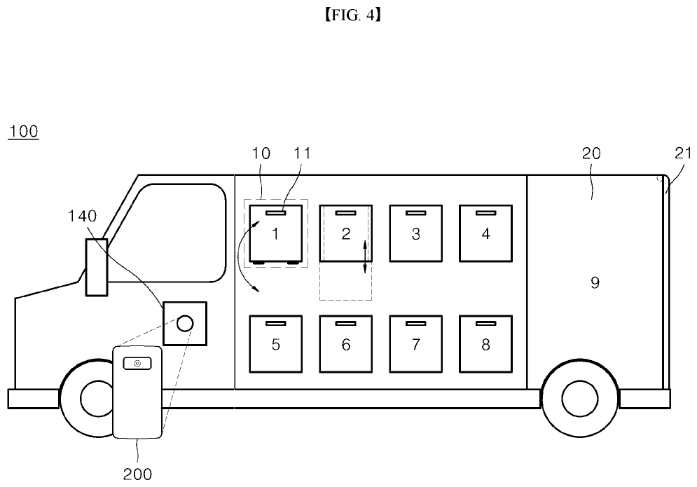

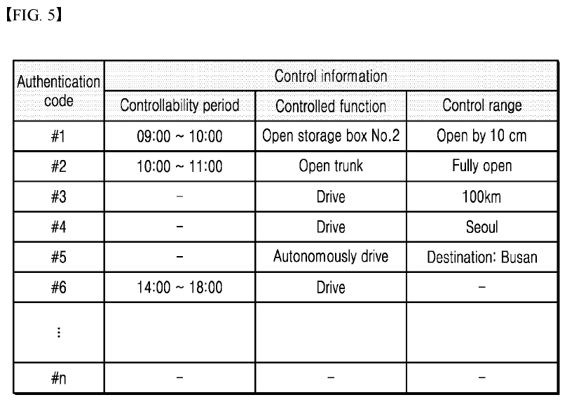

FIG. 4 is a diagram of an example of the autonomous vehicle of FIG. 1, and FIG. 5 is a table illustrating exemplary authentication codes and control information matched thereto.

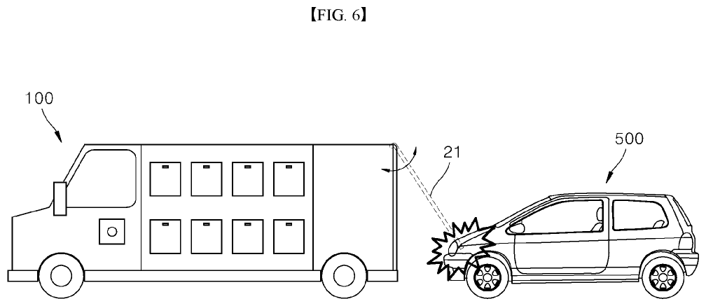

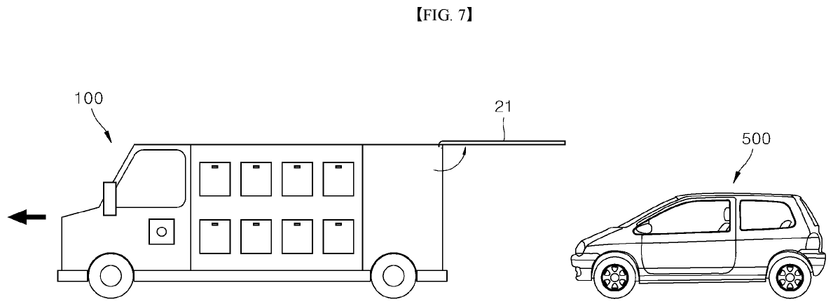

FIG. 6 and FIG. 7 are views illustrating operation of an autonomous vehicle when the autonomous vehicle is in need of additional control due to external factors.

In the following description, it is assumed that operation of an autonomous vehicle is applied to a delivery service and a rental service for convenience of description. However, it will be understood that the present invention is not limited thereto and an operation method of an autonomous vehicle described below may also be applied to various other services.

Referring to FIG. 1, an autonomous vehicle control system 1 according to this embodiment may include an autonomous vehicle 100, a user terminal 200, a manager terminal 300, and a server 400. Although the autonomous vehicle control system 1 is shown as consisting of the aforementioned components in FIG. 1, it will be understood that the present invention is not limited thereto and some components may be added, changed, or omitted, as needed.

The autonomous vehicle 100, the user terminal 200, the manager terminal 300, and the server 400 constituting the autonomous vehicle control system 1 may be connected to one another via a wireless network to perform data communication with one another. Each of the components may use a 5G (5th Generation) mobile communication service for data communication.

Herein, the autonomous vehicle 100 refers to any vehicle that can drive to a destination by itself and may include currently used rental cars, delivery vehicles, shared cars, and the like.

The autonomous vehicle 100 may be associated with artificial intelligence modules, drones, unmanned aerial vehicles, robots, augmented reality (AR) modules, virtual reality (VR) modules, and 5G mobile communication services and devices.

The autonomous vehicle 100 may be used for a delivery service or may be used for a rental service. Accordingly, during operation of the autonomous vehicle 100, a delivery may be stored in the autonomous vehicle 100 or a user may be in the autonomous vehicle 100.

The server 400 may be a cloud-based server. The server 400 may provide information to the autonomous vehicle 100, the user terminal 200 and the manager terminal 300 connected thereto via a wireless network, or may store and manage information collected from the autonomous vehicle 100, the user terminal 200, and the manager terminal 300. The server 400 may be managed by a transport company operating the autonomous vehicle 100, a delivery company providing a delivery service, a rental company providing a car rental service, or the like.

As used herein, the term “user” may refer to a person who receives a service using the autonomous vehicle 100 and the “user terminal” 200 may refer to a terminal possessed by such a person. In addition, the term “manager” may refer to a person who manages or owns the autonomous vehicle 100 and the “manager terminal” 300 may refer to a terminal possessed by such a person.

Next, an operation method of the autonomous vehicle 100 in the autonomous vehicle control system set forth above will be described in detail.

Referring to FIG. 2, the autonomous vehicle 100 according to the embodiment of the invention may include an autonomous driving module 110, an in-vehicle human machine interface (HMI) 120, a database 130, a camera 140, an authentication code management module 150, and a vehicle control module 160. Although the autonomous vehicle 100 is shown as consisting of the aforementioned components in FIG. 2, it will be understood that the present invention is not limited thereto and some components may be added, changed or omitted, as needed. In addition, although not shown in FIG. 2, it will be understood that the autonomous vehicle 100 may include a communication module to perform data communication with the user terminal 200, the manager terminal 300, and the server 400.

Each component of the autonomous vehicle 100 may be implemented by at least one physical element selected from the group of application-specific integrated circuits (ASICs), digital signal processors (DSPs), digital signal processing devices (DSPDs), programmable logic devices (PLDs), field programmable gate arrays (FPGAs), processors, controllers, micro-controllers, and microprocessors.

Referring to FIG. 4, an operation method of the autonomous vehicle 100 according to one embodiment of the present invention may include: generating a first authentication code (S10); matching control information to the first authentication code (S20); and identifying a second authentication code through a camera 140 (S40).

Then, the operation method of the autonomous vehicle 100 may include: performing validation of the second authentication code (S50); identifying control information matched to the second authentication code based on a validation result (S60); and operating based on the identified control information (S70).

The operation method of the autonomous vehicle 100 may be implemented by the components shown in FIG. 2. Now, each step of FIG. 3 will be described with reference to FIG. 2.

As used herein, the term “first authentication code” may refer to an authentication code generated by the autonomous vehicle 100 (specifically, by the authentication code management module 150) and the term “second authentication code” may refer to an authentication code identified through the camera 140. Accordingly, the first and second authentication codes may be collectively referred to as “authentication code” herein.

The authentication code management module 150 may generate the first authentication code (S10).

The first authentication code may include any information usable for validation thereof. For example, the first authentication code may include data corresponding to identification (ID), a password, a unique identifier, and the like.

However, the first authentication code may include image information such that the authentication code can be identified by the camera 140, as described below. More specifically, the first authentication code may include a barcode, a quick response (QR) code, a signature, a picture, a photo, and the like.

When the first authentication code is generated, the authentication code management module 150 may match control information to the first authentication code (S20).

The control information may include information related to operation of the autonomous vehicle 100. More specifically, the control information may include at least one selected from the group of a controlled function indicating which function of the autonomous vehicle 100 is controlled, a control range indicating to what extent the function of the autonomous vehicle 100 is operated, and a controllability period indicating when the function of the autonomous vehicle 100 is available. Operation of the autonomous vehicle 100 based on the control information will be described below with reference to FIG. 5.

The authentication code management module 150 may match a single piece of control information to the first authentication code. Accordingly, the control information corresponding to the first authentication code may be any one piece of information. Here, this feature means that the control information is not any one of the controlled function, the control range, and the controllability period, but one piece of information including at least one selected from the group thereof.

The control information may be input through the in-vehicle HMI 120.

Basically, the in-vehicle HMI 120 may function to visually and audibly output information on the autonomous vehicle 100 or status of the autonomous vehicle to a driver through plural physical interfaces (for example, an audio video navigation (AVN) module).

The in-vehicle HMI 120 may provide an interface for inputting the control information, and a manager may input the control information through the interface.

Alternatively, the autonomous vehicle may receive the control information from the manager terminal 300.

An application for controlling the autonomous vehicle 100 (hereinafter referred to as “vehicle control application”) may be installed on the manager terminal 300 in advance. The vehicle control application may provide an interface for inputting the control information, and a manager may input the control information through the interface. Then, the manager terminal 300 may transmit the control information input by the manager to the autonomous vehicle 100.

When the autonomous vehicle receives the control information through the in-vehicle HMI or from the manager terminal, the authentication code management module 150 may match the control information to the first authentication code and store the matched control information and first authentication code in the database 130. Accordingly, the first authentication code and the control information matched thereto may be stored in the database 130 in a corresponding manner.

Then, the authentication code management module 150 may transmit the first authentication code to the user terminal 200 (S30).

To this end, for example, an address of the user terminal 200 may be input by a manager through the in-vehicle HMI 120. More specifically, the in-vehicle HMI 120 may provide an interface for inputting an address of the user terminal 200, and the manager may input the address of the user terminal 200 through the interface.

In another example, an address of the user terminal 200 may be received from the manager terminal 300. More specifically, the vehicle control application installed on the manager terminal 300 may provide an interface for inputting an address of the user terminal 200 and a manager may input the address of the user terminal 200 through the interface. Then, the manager terminal 300 may transmit the address of the user terminal 200 input by the manager to the autonomous vehicle 100.

When the autonomous vehicle receives the address of the user terminal 200 through the in-vehicle HMI or from the manager terminal 300, the authentication code management module 150 may transmit the first authentication code to the address of the user terminal 200. Accordingly, a user to be provided with a service using the autonomous vehicle 100 may receive the first authentication code through their terminal.

Then, the autonomous vehicle 100 may identify the second authentication code through the camera 140 (S40).

More specifically, a user receiving the authentication code may hold the authentication code displayed on the user terminal 200 up to the camera 140 of the autonomous vehicle 100, and the camera 140 may capture the authentication code to identify the authentication code.

In order for a user to hold the authentication code up to the camera 140 of the vehicle, the user needs to move to the autonomous vehicle 100, or the autonomous vehicle 100 needs to move to a location of the user.

For this purpose, in one embodiment, the autonomous vehicle 100 may autonomously drive to location coordinates of the user terminal 200 when the first authentication code is transmitted to the user terminal 200.

The user terminal 200 may be provided with a GPS module. The GPS (global positioning system) module may acquire location coordinates thereof by analyzing signals from a satellite. Since the GPS module is embedded in the user terminal 200, the location coordinates acquired by the GPS module may be location coordinates of the user terminal 200.

Likewise, the autonomous vehicle 100 may also be provided with a GPS module, and the GPS module in the autonomous vehicle 100 may operate in the same manner as the GPS module in the user terminal 200.

The server 400 may receive location coordinates of the user terminal 200 (hereinafter referred to as “terminal coordinates”) from the user terminal 200 and location coordinates of the autonomous vehicle 100 (hereinafter referred to as “vehicle coordinates”) from the autonomous vehicle 100.

The server 400 may generate a driving route from the vehicle coordinates to the terminal coordinates based on traffic information. For this purpose, the server 400 may be connected to a traffic information server via a network to receive current traffic conditions from the traffic information server. Here, the traffic information server is a server that manages real-time information relating to traffic, such as roadway information, traffic congestion, and road conditions, and may be a state-run or private server.

Generating the driving route based on the traffic information may be implemented by any suitable method known in the art, and detailed description thereof will be omitted herein.

The server 400 may transmit the generated driving route to the autonomous vehicle 100, which in turn may autonomously drive based on the driving route received from the server 400. More specifically, the autonomous driving module 110 may control the autonomous vehicle 100 to drive along the driving route. For this purpose, the autonomous driving module 110 may implement an algorithm to conduct inter-vehicle gap keeping, lane departure prevention, lane tracking, traffic light detection, pedestrian detection, structure detection, traffic condition detection, and autonomous parking. In addition, various other known algorithms may be implemented to help autonomous driving.

Alternatively, the driving route may be generated by the autonomous vehicle 100 itself. In this case, the autonomous vehicle 100 may receive the terminal coordinates from the user terminal 200 and the traffic information from the traffic information server. The autonomous driving module 110 may generate a driving route from the vehicle coordinates to the terminal coordinates based on the traffic information and may autonomously drive along the generated driving route.

In another embodiment, the autonomous vehicle 100 may receive a destination through the vehicle HMI 120 when the first authentication code is transmitted to the user terminal 200. Here, the destination may be a location where a user wants to be provided with a service using the autonomous vehicle 100.

The in-vehicle HMI 120 may provide an interface for inputting the destination, and a manager may input the destination through the interface.

In a further embodiment, the autonomous vehicle 100 may receive the destination from the manager terminal 300 when the first authentication code is transmitted to the user terminal 200,

The vehicle control application installed on the manager terminal 300 may provide an interface for inputting the destination, and a manager may input the destination through the interface. The, the manager terminal 300 may transmit the destination input by the manager to the autonomous vehicle 100.

Upon receiving the destination from the manager terminal or through the in-vehicle HMI, the autonomous vehicle 100 may autonomously drive to the destination. More specifically, the autonomous driving module 110 may generate a driving route from the vehicle coordinates to the destination in consideration of the traffic information and may autonomously drive along the generated driving route.

By any one of the methods according to the above embodiments, the autonomous vehicle 100 can move to a location of a user, and the user can hold the second authentication code up to the camera 140 of the autonomous vehicle 100 that has arrived at their location.

Referring to FIG. 4, the camera 140 may be installed on any outer surface of the autonomous vehicle 100, such as a side surface, to capture the authentication code. A user receiving the first authentication code may hold the first authentication code displayed on the user terminal 200 up to the camera 140 of the vehicle. Accordingly, the camera 140 may capture the first authentication code, which in turn may be identified as the second authentication code.

As described above, the authentication code may include the image information and thus the camera 140 may identify the second authentication code by converting the image information into data. For example, when the authentication code is a barcode or a QR code, the camera 140 may identify the authentication code based on reading the barcode or the QR code. In addition, converting the image information into data through the camera 140 may be implemented by any typical method used in the art, and detailed description thereof will be omitted herein.

When the second authentication code is identified, the authentication code management module 150 may perform validation by ascertaining whether the second authentication code is identical to the first authentication code (S50).

In other words, the authentication code management module 150 may verify the authentication code identified through the camera 140 by ascertaining whether the authentication code identified through the camera 140 is the same as the authentication code generated thereby.

For this purpose, the authentication code management module 150 may compare the second authentication code identified through the camera 140 with a plurality of first authentication codes stored in the database 130.

As described above, the authentication code management module 150 may store the first authentication code and the control information matched thereto in the database 130 in a corresponding manner. Since such a storage operation may be performed each time the first authentication code is generated, a plurality of first authentication codes and control information corresponding thereto may be stored in the database 130.

If the second authentication code identified through the camera 140 is any one of the plural first authentication codes stored in the database 130, the authentication code management module 150 may validate the second authentication code, that is, may confirm validity of the second authentication code.

The autonomous vehicle 100 may identify the control information matched to the second authentication code based on verification results (S60).

If none of the plurality of first authentication codes matches the second authentication code and thus validation fails, the authentication code management module 150 may transmit a validation failure message to the manager terminal 300. Accordingly, a manger may ascertain that a person who does not have the first authentication code attempts to control the autonomous vehicle 100.

On the contrary, if the second authentication code matches any one of the plurality of first authentication codes and validation succeeds, the authentication code management module 150 may identify the control information matched to the second authentication code. In other words, the authentication code management module 150 may identify the control information matched to the first authentication code identical to the second authentication code by referring to the database 130.

As described above, the control information may be information relating to operation of the autonomous vehicle 100. When the control information is identified, the autonomous vehicle 100 may operate based on the identified control information (S70).

The control information may include at least one selected from the group of the controlled function, the control range, and the controllability period. Here, the autonomous vehicle 100 may perform the controlled function within the control range for the controllability period. In other words, the autonomous vehicle 100 may perform a specific function to a predetermined extent for a predetermined period of time.

Next, examples of the control information and operation of the autonomous vehicle 100 based thereon will be described.

The autonomous vehicle 100 may open a vehicle door based on the control information.

Referring to FIG. 4, the autonomous vehicle 100 may be used for a delivery service. For this purpose, the autonomous vehicle 100 may be provided with a plurality of storage boxes 10, a trunk 20, and a door to open/close each of the plurality of storage boxes 10 and the trunk 20. Hereinafter, a door to open/close each storage box 10 will be referred to as “storage box door” 11 and a door to open/close the trunk 20 will be referred to as “trunk door” 21.

Referring to FIG. 5, in order to deliver an item ordered by a user through an online shopping mall or the like, a manager may generate authentication code #1 through the autonomous vehicle 100.

The manager may put the ordered item into storage box No. 2 of the autonomous vehicle 100. Accordingly, the manager may match control information including a controlled function defined by “open storage box No. 2” to authentication code #1 through the autonomous vehicle 100.

The autonomous vehicle 100 may autonomously drive to a destination after transmitting authentication code #1 to the user terminal 200, and a user may hold authentication code #1 up to the camera 140 of the autonomous vehicle 100 that has arrived at the destination to verify their authority to control the vehicle.

When the authentication code is validated, the vehicle control module 160 may open storage box No. 2 by providing an opening control signal to storage box No. 2, and the user may receive the item stored in storage box No. 2.

In addition to simply opening a vehicle door, the autonomous vehicle 100 may further control an opening degree of the vehicle door based on the control information.

In the above example, the item ordered by a user may have a size of about 10 cm. Accordingly, a manager may further match control information including a control range defined by “open by 10 cm” to authentication code #1.

As a result, upon opening the vehicle door, the vehicle control module 160 may open storage box No. 2 only by 10 cm. More specifically, as shown in FIG. 4, the storage box door 11 may be hinged at a lower portion thereof to a side surface of the vehicle such that an upper portion thereof is pivoted about the hinged lower portion. Alternatively, the storage box door 11 may be configured to slide up and down.

Here, a pivoting degree or sliding degree of the storage box door 11 may be adjusted by a control signal provided by the vehicle control module 160. The vehicle control module 160 may open the storage box door 11 only by about 10 cm through the control signal, and a user may receive the item through the open space.

In addition, the operation of opening a vehicle door may be performed only for a specific period of time.

In the above example, a manger may ascertain that a delivery time of the item is between 9 and 10 o'clock based on an address of a destination of delivery. Accordingly, the manager may further match control information including a controllability period defined by “09:00 to 10:00” to authentication code #1.

As a result, the operation of opening the vehicle door may be performed only between 9 and 10 o'clock, set as the controllability period. More specifically, the vehicle control module 160 may provide a control signal to the storage box door 11 only between 09 and 10 o'clock regardless of whether the authentication code is validated or not. Accordingly, a user can receive the item through the open space only between 9 and 10 o'clock.

In addition, the first authentication code may be generated on a predetermined periodic basis and transmitted to the user terminal 200.

Referring again to FIG. 5, the autonomous vehicle 100 may be a vehicle that is operated for a periodic delivery service. For example, the autonomous vehicle 100 may be a vehicle for a breakfast pickup service and thus may deliver breakfast between 9 and 10 o'clock every day.

Accordingly, the autonomous vehicle 100 may automatically generate authentication code #1 on a predetermined periodic basis, for example, every 24 hours, and the generated authentication code #1 may be transmitted to the user terminal 200 before 9 am every morning.

As a result, the autonomous vehicle 100 may perform, every day, generation of authentication code #1, validation of authentication code #1 through the camera 140, and opening of storage box No. 2 by 10 cm without manager intervention.

If the control information includes the controllability period, the autonomous vehicle 100 may perform validation of the authentication code only for the controllability period. For this purpose, the autonomous vehicle 100 may turn the camera 140 on when the controllability period is reached and may identify the second authentication code through the turned-on camera 140 for the controllability period.

Referring again to FIG. 5, the manger may generate authentication code #2, and may match control information including a controllability period defined by “10:00 to 11:00”, a controlled function defined by “open trunk”, and a control range defined by “fully open” to authentication code #2.

Here, the vehicle control module 160 may provide an on-control signal to the camera 140 at 10 o'clock and may provide an off-control signal to the camera 140 at 11 o'clock. In other words, the camera 140 can be in an “on” state between 10 and 11 o'clock, and thus can identify the second authentication code only between 10 and 11 o'clock.

Accordingly, a user may verify their authority to control the vehicle between 10 and 11 o'clock, and the autonomous vehicle 100 may fully open the trunk door 21 only between 10 and 11 o'clock.

If the autonomous vehicle 100 is used for a rental service, the autonomous vehicle 100 may autonomously drive within a predetermined constraint based on the control information.

In one example, the predetermined constraint may be a driving distance. Referring to FIG. 5, in order to rent the autonomous vehicle 100 to a user, a manger may generate authentication code #3 through the autonomous vehicle 100 and may match control information including a controlled function defined by “drive” and a control range defined by “drive by 100 km” to authentication code #3.

When the authentication code is then verified by the user, the autonomous vehicle 100 may provide an authority to drive to the user until the driving distance of vehicle reaches 100 km. Here, a count-start time may be a time when the authentication code is validated.

In another example, the predetermined constraint may be a driving location. Referring again to FIG. 5, in order to rent the autonomous vehicle 100 to a user, a manager may generate authentication code #4 through the autonomous vehicle 100 and may match control information including a controlled function defined by “drive” and a control range defined by “drive in Seoul” to authentication code #4.

When the authentication code is then authenticated by the user, the autonomous vehicle 100 may provide an authority to drive to the user under conditions that the driving location of the vehicle is in Seoul. Here, the autonomous vehicle 100 may determine whether the driving location of the autonomous vehicle 100 is in Seoul based on comparing location coordinates acquired by the GPS module with location coordinates of Seoul.

In a further example, the predetermined constraint may be a destination. Referring again to FIG. 5, in order to rent the autonomous vehicle 100 to a user, a manager may generate authentication code #5 through the autonomous vehicle 100 and may match control information including a controlled function defined by “autonomously drive” and a control range defined by “destination: Busan” to the authentication code #5.

When the authentication code is then authenticated by the user and the user boards the autonomous vehicle 100, the autonomous vehicle 100 may autonomously drive from a current location to Busan. Since autonomous driving of the vehicle is described above, detailed description thereof will be omitted

In another example, the predetermined constraint may be a driving time. Referring again to FIG. 5, in order to rent the autonomous vehicle 100 to a user, a manager may generate authentication code #6 through the autonomous vehicle 100 and may match control information including a controlled function defined by “drive” and a controllability period defined by “14:00 to 18:00” to authentication code #6.

When the authentication code is then authenticated by the user, the autonomous vehicle 100 may provide an authority to drive to the user from 14:00 to 18:00.

In addition, the autonomous vehicle 100 may receive additional control information from the user terminal 200 and may transmit the received additional control information to the manager terminal 300. Then, the autonomous vehicle 100 may receive a control approval signal from the manager terminal 300 and may operate based on the additional control information input by a user in response to the control approval signal.

Referring to FIG. 6, there may be occasions when the autonomous vehicle 100 may not be able to perform opening of a vehicle door due to a nearby vehicle 500. More specifically, upon performing an operation matched to authentication code #2 of FIG. 5, the autonomous vehicle 100 may not be able to open the trunk door 21 due to the nearby vehicle 500 located in the rear thereof.

In this case, a user may input additional control information for advancing the autonomous vehicle 100 through the user terminal 200. More specifically, the user may input the additional control information through an interface provided by the vehicle control application installed on the user terminal 200. The additional control information input through the user terminal 200 may be received by the autonomous vehicle 100, which in turn may transmit the additional control information to the manager terminal 300.

When the manager terminal receives the additional control information, the vehicle control application installed on the manager terminal 300 may provide an interface for inputting a control approval signal and a manager may input the control approval signal for approval of additional control through the interface.

The manager terminal 300 may transmit the control approval signal input by the manager to the autonomous vehicle 100, which in turn may move forward based on the additional control information received from the user terminal 200 in response to the control approval signal.

As a result, the autonomous vehicle 100 may advance, as shown in FIG. 7, whereby the trunk door 21 which has not been able to be opened due to the nearby vehicle 500 in the rear of the autonomous vehicle can be opened.

Similar to the aforementioned method, if a user wants to change a driving distance, a driving location, a driving time, and a destination while the autonomous vehicle performs driving or autonomous driving, the user may input additional control information through the user terminal 200. Upon receiving a control approval signal for approval of additional control from a manager, the autonomous vehicle 100 may operate based on the additional control information.

In addition, upon detection of an operation outside a constraint contained in the control information or the additional control information, the autonomous vehicle 100 may transmit an alert message to the manager terminal 300.

For example, referring again to FIG. 4 and FIG. 5, when a different storage box rather than storage box No. 2 is forcibly opened contrary to control information matched to authentication code #1 while the autonomous vehicle operates based on the control information, the autonomous vehicle 100 may transmit an alert message to the manager terminal 300.

For another example, when acquired GPS coordinates of the autonomous vehicle indicate that the autonomous vehicle is outside Seoul contrary to control information matched to authentication code #4 while the autonomous vehicle operates based on the control information, the autonomous vehicle 100 may transmit an alert message to the manager terminal 300.

In an operation based on the control information or the additional control information described above, the autonomous vehicle 100 may transmit an image captured by the camera 140 to the manager terminal 300.

More specifically, the camera 140 may capture a visual image of the outside, in addition to capturing the authentication code to identify the authentication code. After validation of the authentication code, the autonomous vehicle 100 may capture a visual image of the outside to detect user movement and surrounding conditions and may transmit the captured image to the manager terminal 300.

As a result, a manager can remotely determine whether a user attempts to control the autonomous vehicle to a degree exceeding their authority, whether the user legitimately receives an item loaded on the autonomous vehicle, whether there are risk factors outside the autonomous vehicle, and the like.

Upon completion of the operation based on the control information, the autonomous vehicle 100 may delete the first authentication code identical to the second authentication code from the database 130.

More specifically, upon completion of the use of the autonomous vehicle 100, a user may input a completion signal through an interface disposed on the outer surface of the autonomous vehicle 100, or may input a completion signal through the user terminal 200. The completion signal input through the user terminal 200 may be transmitted to the autonomous vehicle 100.

When the autonomous vehicle 100 receives the completion signal through the interface on the outer surface thereof or from the user terminal, the authentication code management module 150 of the autonomous vehicle 100 may delete an authentication code used to operate the autonomous vehicle 100 among the plurality of authentication codes stored in the database 130 and control information corresponding to the authentication code.

As a result, a user who controlled the autonomous vehicle once using an authentication code cannot control the autonomous vehicle again using the same authentication code, thereby allowing improvement in security of service provision.

As described above, according to the present invention, the autonomous vehicle 100 can prevent an unauthorized user from controlling the autonomous vehicle by validating a user's authority to control the autonomous vehicle 100 through an authentication code and allowing the autonomous vehicle 100 to operate in a limited manner based on control information matched to the authentication code; and can prevent a user from misusing or abusing functions of the autonomous vehicle 100 by providing a limited authority to the user.

Although some embodiments have been described herein, it should be understood that these embodiments are provided for illustration only and are not to be construed in any way as limiting the present invention, and that various modifications, changes, alterations, and equivalent embodiments can be made by those skilled in the art without departing from the spirit and scope of the invention.

1. An operation method of an autonomous vehicle using an authentication code, comprising:
generating a first authentication code;
matching control information to the first authentication code;
transmitting the first authentication code to a user terminal;
identifying a second authentication code through a camera;
performing validation by ascertaining whether the second authentication code is identical to the first authentication code;
identifying control information matched to the second authentication code based on a validation result; and
operating based on the identified control information.

2. The operation method according to claim 1, wherein the first authentication code and the second authentication code comprise image information.

3. The operation method according to claim 1, wherein the step of matching the control information to the first authentication code comprises:
receiving the control information through an in-vehicle HMI or from a manager terminal; and
matching the control information to the first authentication code and storing the matched control information and the first authentication code in a database.

4. The operation method according to claim 1, wherein the control information comprises at least one selected from the group of a controlled function, a control range, and a controllability period.

5. The operation method according to claim 4, wherein the step of operating based on the identified control information comprises performing the controlled function within the control range for the controllability period.

6. The operation method according to claim 1, wherein the step of transmitting the first authentication code to the user terminal comprises:
receiving an address of the user terminal through an in-vehicle HMI or from a manager terminal; and
transmitting the first authentication code to the address of the user terminal.

7. The operation method according to claim 1, wherein:
the step of generating the first authentication code comprises generating the first authentication code on a predetermined periodic basis; and
the step of transmitting the first authentication code to the user terminal comprises transmitting the first authentication code generated on the predetermined periodic basis to the user terminal.

8. The operation method according to claim 1, further comprising:
autonomously driving to location coordinates of the user terminal when the first authentication code is transmitted to the user terminal.

9. The operation method according to claim 1, further comprising:
receiving a destination through an in-vehicle HMI or from a manager terminal when the first authentication code is transmitted to the user terminal; and
autonomously driving to the destination.

10. The operation method according to claim 1, wherein the step of identifying the second authentication code through the camera comprises:
turning the camera on when a controllability period corresponding to the control information is reached; and
identifying the second authentication code through the turned on camera for the controllability period.

11. The operation method according to claim 1, wherein the step of performing validation by ascertaining whether the second authentication code is identical to the first authentication code comprises validating the second authentication code when the identified second authentication code is any one of a plurality of first authentication codes stored in a database.

12. The operation method according to claim 1, wherein the step of operating based on the identified control information comprises opening a vehicle door based on the control information.

13. The operation method according to claim 12, wherein the step of opening the vehicle door based on the control information comprises controlling an opening degree of the vehicle door based on the control information.

14. The operation method according to claim 1, wherein the step of operating based on the identified control information comprises autonomously driving within a predetermined constraint based on the control information.

15. The operation method according to claim 1, further comprising:
receiving additional control information from the user terminal;
transmitting the received additional control information to a manager terminal;
receiving a control approval signal from the manager terminal; and
operating based on the additional control information received from the user terminal in response to the control approval signal.

16. The operation method according to claim 1, further comprising:
transmitting an image captured by the camera to a manager terminal while operating based on the control information.

17. The operation method according to claim 1, further comprising:
transmitting an alert message to a manager terminal upon detection of an operation outside a constraint contained in the control information.

18. The operation method according to claim 1, further comprising:
deleting the first authentication code identical to the second authentication code from a database upon completion of an operation based on the control information.
